(19) United States
(12) Patent Application Publication
(10) Pub. No.: US 2006/0267998 A1
(43) Pub. Date: Nov. 30, 2006

(54) Systems and methods for management of parameters in a multi-node graphics system

(76) Inventors: Jeffrey Joel Walls, Fort Collins, CO (US); Donley Byron Hoffman, Fort Collins, CO (US); Byron Alan Alcorn, Fort Collins, CO (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/136,192

(22) Filed: May 24, 2005

(51) Int. Cl. G09G 5/00

(52) U.S. Cl. 345/581

(57) ABSTRACT

Embodiments of the present invention are broadly directed to multi-node computer graphics system comprising a plurality of render nodes configured to collectively render a graphics image. The system further comprises a datastore configured to store parameters that are used to control the rendering of the graphics image and a datastore manager configured to manage the parameters stored in the datastore. In addition, the system comprises a plurality of entities associated with the plurality of render nodes, each of the plurality of entities being configured to implement an operation based on at least one parameter. The system also comprises logic associated with the plurality of render nodes for proactively retrieving at least one parameter from the datastore and communicating the retrieved parameter to at least one of the plurality of entities for using the parameter to implement an operation.

### BACKGROUND OF THE INVENTION

The rendering of three-dimensional computer graphics is a computationally-intensive process. In many high-end applications, three-dimensional computer graphics are rendered using a pool or group of computers, which share the processing responsibilities. In such a system, one computer may be configured to execute at least one application program and communicate graphics data to other computers for processing and rendering. In this regard, a collection of computers may be configured to cooperatively render a graphics image and may receive the graphics data to be rendered from the computer executing the application program.

When multiple computers are used to render a single scene or image, the video signals generated by each of those computers are combined into a single aggregate (or composite) signal and encoded in a particular format, such as NTSC (National Television Standards Committee), PAL (phase alteration by line), etc. There exist devices called compositors that perform the function of combining (or compositing) multiple video signals into a single, composite video signal. Accordingly, there are known approaches for performing the functions of a compositor.

In operation, a host or master computer is configured to execute an application program, which generates three-dimensional graphics for presentation to a user. Program control, two-dimensional graphics and windows, user interface functions, and other aspects may be performed on the master or host computer. Three-dimensional graphics-rendering operations, however, are performed by a plurality (or cluster) of slave or render nodes. In such a system, a significant amount of data and other information is communicated from the host or master computer to the render nodes for rendering. As graphics scenes change, windows are moved or resized, or content within the windows is changed, additional communications occur between the host computer and the various render nodes in order to communicate changed information to the render nodes for rendering.

Reference is now made to the drawings, in which FIG. 1 illustrates a multi-node system for rendering three-dimensional graphics. Many high-end or intensive graphic programs are executed, and graphics images are rendered, using a plurality of computers in combination. There are various ways in which multiple computers are configured to operate either in parallel or in conjunction to perform a graphics-rendering task. One way is to configure one computer 110 to operate as a master (or host), and configure the remaining plurality of computers 120 to operate as slaves (or render nodes). In the illustrated embodiment, the slave computers 120 are configured to collectively render a three-dimensional graphics image. The rendering among the slave computers 120 is partitioned or allocated in a variety of ways. One way is to divide the screen space into various partitions and have each slave computer render the data associated with its partition.

In the embodiment illustrated in FIG. 1, the master computer 110 executes an application program 112 that involves the rendering of three-dimensional graphics. The control and functionality of the application program 112 is handled by the master computer 110. As well, the master computer 110 handles various two-dimensional graphics rendering that is incidental to the execution of the application program 112. For example, the presentation of drop-down menus or other items of presentation that do not require three-dimensional rendering is performed by the master computer 110. Each of the computers (master computer 110 and each of the slave computers 120) comprises a graphics card (or other graphics circuitry) that outputs a signal for a video display 140. Since, however, the content that is rendered by each of the computers is first combined, the video outputs of each of the computers are delivered to a compositor 130. A compositor 130 operates to combine the content of each of the plurality of input video signals to deliver a single, composite output signal 132 that is used to drive a display device 140.

An alternative environment comprises multiple displays 140 that are configured to operate as a single logical display. There are a variety of applications in which graphics information is presented over a panel or matrix of displays, to effectively emulate a single, large display. Examples of such systems include: real estate, financial (such as the stock market), control room, large engineering processes, military mapping, telecommunications, etc. Such systems require the output of large amounts of data, which can easily exceed the viewable display capacity of a single, physical monitor (a user could view relevant data only by panning and zooming).

In such complex, multi-node systems, a large number of items must be configured and maintained during execution. For example, the master computer 110 configures various processes and threads to run on slave (e.g., render) nodes. Thereafter, as state or operational parameters change based on, for example, events in the execution of the application program, the master computer 110 communicates information defining or relevant to such changes to the impacted slave nodes. Further, such systems operate by the master computer 110 configuring and updating the various slave nodes in a serial fashion, which requires additional time before all nodes are properly configured or updated, such that they can continue processing.

### DESCRIPTION OF THE DRAWINGS

The accompanying drawings incorporated in and forming a part of the specification, illustrate several aspects of the present invention, and together with the description serve to explain the principles of the invention. In the drawings:

FIG. 1 is a diagram illustrating a multi-node graphics-rendering system.

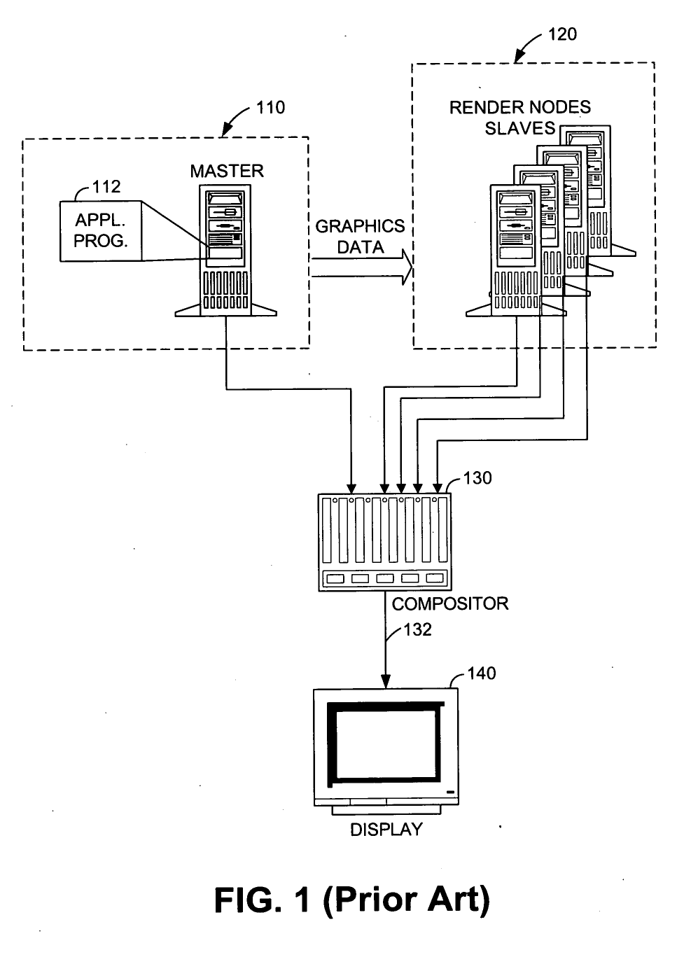

FIG. 2 is a diagram illustrating certain components of an embodiment of the present invention.

FIG. 3 is a diagram illustrating certain components of another embodiment of the present invention.

FIG. 4 is diagram illustrating certain components of an embodiment of the present invention, utilized for implementing a gamma correction operation.

FIG. 5A is a diagram illustrating certain components associated with a node hosting a datastore and datastore manager, in accordance with one embodiment.

FIG. 5B is a diagram illustrating certain components of a render node, in accordance with one embodiment.

FIG. 6 is a flow chart illustrating a top-level functional operation of an embodiment.

FIG. 7A is a diagram similar to FIG. 5A, illustrating an alternative embodiment.

FIG. 7B is a diagram similar to FIG. 5B, illustrating an alternative embodiment.

FIG. 8 is a flow chart illustrating a top-level operation of an alternative embodiment.

FIG. 9 is a flow chart illustrating yet another embodiment.

### DETAILED DESCRIPTION

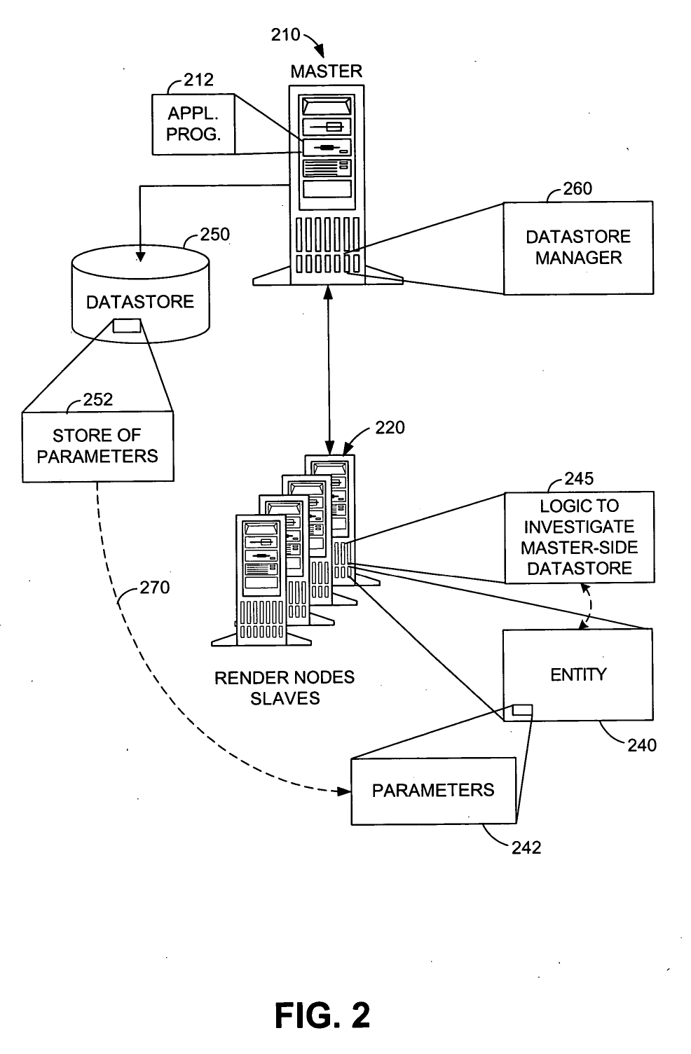

Reference is now made to FIG. 2, which is a diagram illustrating certain components of an embodiment of the present invention. In the embodiment illustrated in FIG. 2, a master computer (or host) 210 is configured to have a datastore 250 which stores, among other things, various operational parameters 252. These parameters are utilized for, or otherwise define, a wide variety of system and operational aspects. For example, the plurality of render and other slave nodes may be configured to host or control a variety of entities, such as a multicaster, a database, a datastore manager, a window controller, a slave controller, gamma correction, etc. Parameters relevant to these and other operating modes, aspects, and configurations are maintained within the datastore 250.

Likewise, the master 210 also comprises a datastore manager 260. This manager 260 is a process that is responsible for the control and management of the information in the datastore 250. Also illustrated in FIG. 2 are a plurality of slave computers 220, which comprise a plurality of render nodes that are configured to collectively render a graphics image. A plurality of entities are configured for operation within or among the plurality of slave computers 220. In this regard, an “entity” comprises processes and threads that are configured for execution on, or operation within, various of the plurality of slave computers 220. One such entity 240 is illustrated in FIG. 2. For purposes of this illustration, the entity 240 has been generically designated as “entity.” It should be appreciated, however, that this and other entities (not specifically shown for simplicity) encompass a wide variety of functions and tasks appropriate for carrying out the operations of the various slave computers 220. In this regard, in operation, the entity 240 uses certain information or parameters that are supplied by the host computer 210. A dashed line 270 is used to illustrate the concept that one or more of the parameters 252 stored in the database 250 is communicated to the entity 240, where it is saved as a parameter 242.

Consistent with the scope and spirit of the illustrated embodiment, the plurality of render nodes 220 also comprise logic 245 that is configured to query, investigate, or otherwise request certain parameters from the host 210 in connection with the configuration or operation of the entity 240. In this regard, prior art systems are generally characterized as incurring excessive timing delays and overhead associated with the host computer 210 in connection with the communication of various parameters that are utilized by the various entities on the plurality of slave computers. However, in the embodiment illustrated in FIG. 2, this excessive overhead and delay is substantially reduced by configuring logic 245 that resides or operates in connection with the slave nodes 220 to proactively query or request relevant parameters from the host computer 210. In this way, the host computer 210 need not serially communicate parameters to each of a plurality of relevant slave-side entities, each time a parameter is changed through, for example, the execution of the application program 212. Instead, at relevant times, the plurality of slave computers 220 will request the relevant data.

Significant timing-delay improvements and overhead reductions, as observed by a master computer, are realized in embodiments in which a single communication from the master to a slave-side entity serves to update parameters for a plurality of slave-side entities. For example, a parameter (or set of parameters) may be communicated to a slave-side process, which in-turn relays the parameter (or set of parameters) to a plurality of slave-side entities.

The time and manner in which the slave computers 220 request the relevant information and parameters 252 varies from embodiment to embodiment, and also varies based upon configuration of the specific entities (e.g. 240) and logic (e.g. 245). In one embodiment, the logic 245 is configured to periodically query the host computer 210 to determine if certain parameters have been updated and, if so, to request the updated parameters. In another embodiment, the logic 245 is configured to request certain parameters before a particular operation is carried out by the entity 240 (this embodiment ensures that entity 240 has the most current, relevant parameters for a given aspect of its operation). In yet another embodiment, various entities and associated logic of the slave nodes 220 may request that the host computer 210 communicate any updates in certain parameters as the parameters are updated. Again, it will be appreciated that the particular implementation will vary from embodiment to embodiment, and may further vary based upon the particular operation or function that is being carried out by the relevant slave-side entities.

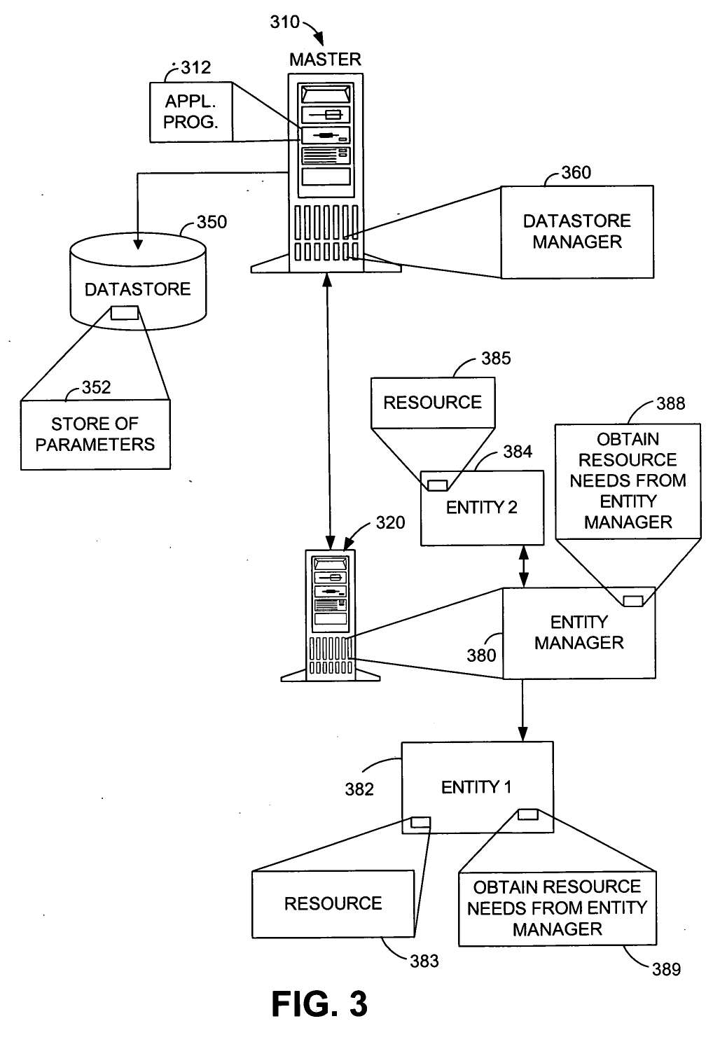

Reference is now made to FIG. 3, which is a diagram illustrating another embodiment of the present invention. In the embodiment of FIG. 3, a host computer 310 is configured to execute an application program 312. Like the embodiment illustrated in FIG. 2, the host 310 further comprises datastore 350 and datastore manager 360, which operate similar to the datastore 250 and datastore manager 260 described in connection with FIG. 2. On the slave side, a single render node 320 is illustrated. It should be appreciated that additional render nodes, as well as additional slave computers, exist in the system, but for simplicity of illustration, only a single render node is illustrated. Among other components and features, the render node 320 comprises an entity manager 380 that is configured to manage a plurality of entities (e.g., 382 and 384). Each entity 382 and 384 comprises parameters, information, or other resources 383 and 385, which are used for the configuration or operation of the respective entities. Logic 388 is provided in connection with the entity manager 380 for obtaining resources from the master computer 310 that are utilized in connection with the configuration or operation of one or more of the entities 382 and 384 that are managed by the entity manager 380. As described in connection with the logic 245 of FIG. 2, the logic 388 may be configured to obtain the parameters or resources from the master computer 310 in a variety of ways (e.g., periodic requests, requests when resources are needed, standing requests to be advised of parameter or resource updates, etc.). Likewise, logic 389 is provided in connection with one or more of the respective entities 382 and 384 for performing a similar function as logic 388 (only with respect to different resources or parameters). Whether resources or parameters are requested through logic 388 and/or logic 389 varies from embodiment to embodiment based upon design considerations and other factors.

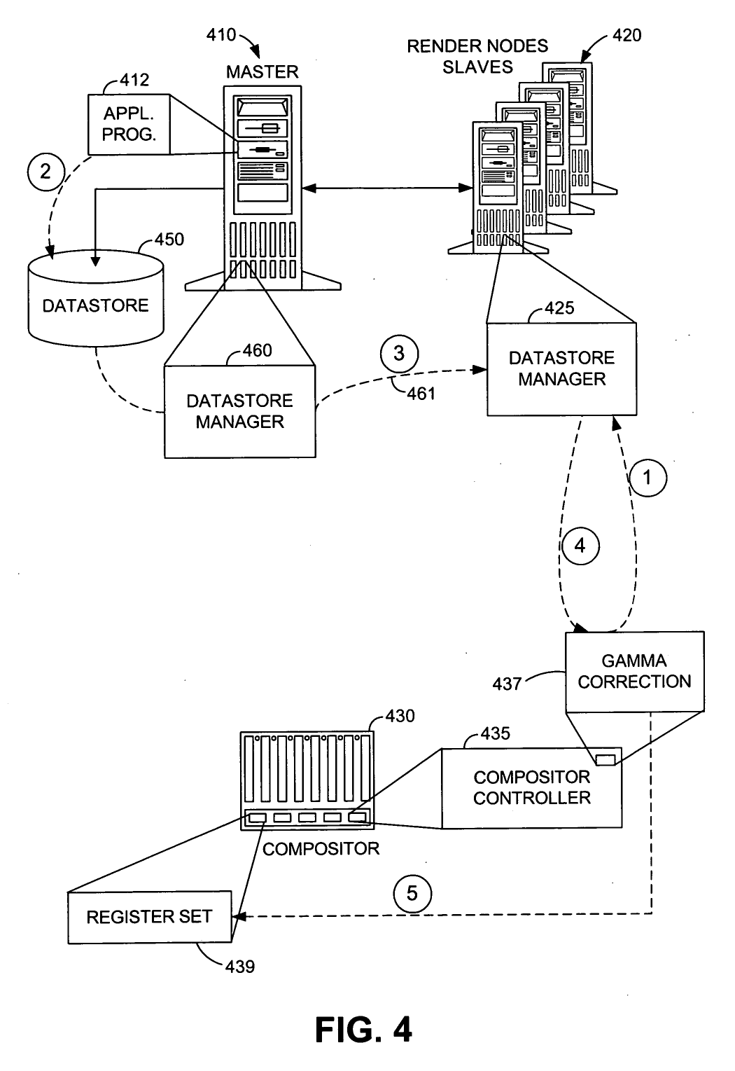

To further illustrate the concepts that have been generically described above, reference is now made to FIG. 4, which is a diagram illustrating certain components of an embodiment of the present invention. In this regard, FIG. 4 is provided to illustrate the operation of an embodiment of the present invention in the context of a gamma correction operation.

With regard to gamma correction, a computer monitor displays colors by exciting phosphors on the screen. However, phosphors do not excite linearly. For example, if a computer reads a luminance value from a photographic image and sends it directly to the monitor, the displayed color will be dimmer than in the original photograph. This nonlinear relationship is closely approximated by a power function, i.e. displayed₁₃ intensity=pixel_valueˆgamma (where “ˆgamma” denotes “gamma” as an exponential value to the pixel_value). Most monitors have a gamma value between 1.7 and 2.7. Gamma correction consists of applying the inverse of this relationship to the image before display, i.e. by computing new_pixel_value=old_pixel_valueˆ(1.0/gamma).

By convention, the “displayed_intensity” and “pixel_value” values are both scaled to the range 0.1, with 0 representing black and 1 representing maximum white (or red, etc). Normalized in this way, the power function is completely described by a single number: the exponent “gamma.” In computer rendering systems, gamma correction is typically implemented in graphics hardware downstream of the frame buffer.

In the embodiment of FIG. 4, a compositor 430 is configured to receive video signals provided from a plurality of render nodes 420 and to generate a single, composite output signal for driving a display. In this system, the function of gamma correction is performed within the compositor 430. A compositor controller 435 is provided to control various operational aspects of the compositor 430. Among other components and aspects, the compositor controller 435 comprises logic 437 for performing a gamma-correction operation. In addition, the compositor 430 comprises a register or register set 439 that stores values that are utilized in connection with the gamma-correction operation. In operation (after the initial system-wide configuration), the gamma-correction logic provides a request to a datastore manager 425, which is associated with the render nodes 420. During execution of an application program 412, the gamma-correction value is changed. The application program communicates this change (or otherwise stores the changed value) in the datastore 450. A datastore manager 460, thereafter, notifies 461 the slave-side datastore manager 425. As further described herein, this notification 461 may occur in any of a variety of ways (e.g., in response to specific requests from the datastore manager 425). After the datastore manager 425 recognizes the change in the gamma correction value, it communicates 427 this change to the gamma correction logic 437, as the gamma correction logic 437 has previously requested 423 to be notified of any such changes. Thereafter, the gamma correction logic 437 communicates the new values to the register set 439.

In one embodiment, multiple compositors are configured to drive multiple monitors that are configured in a SLS (single logical screen) system. Each compositor in that embodiment receives its corresponding input from a plurality of render nodes. A single communication from the master 410 to the datastore manager 425 (via datastore 450 and datastore manager 460), with subsequent communications from the datastore manager 425 to the gamma correction logic of each of the respective compositors, effects the gamma correction. In previous systems, the master computer 410 would have serially communicated the changed gamma correction values to each of the compositors. Therefore, it is readily observed through this example how the proactive queries from the slave-side entities or entity controllers significantly reduce the overhead and timing delay otherwise encountered by the master computer.

The foregoing has described certain features in connection with a “pull” aspect of embodiments of the invention. In this respect, “pull” refers to the action of slave nodes or entities pulling information from a master or host. In accordance with various embodiments, this pulling may occur as a result of a direct request from an entity to the master or host for specified parameters or information. Such a request could be made before the entity performs an action that will utilize the parameters or information. Such a request could, alternatively, be made on periodic bases. In other embodiments, the pulling may occur by lodging a standing request with the master or host to advise an entity whenever specified parameters or information have changed. If multiple entities place such standing requests with a master or host computer for the same parameters, then the master communicates changes in such specified parameters to the requesting slave computer simultaneously, by utilizing broadcast or multicast messaging protocols.

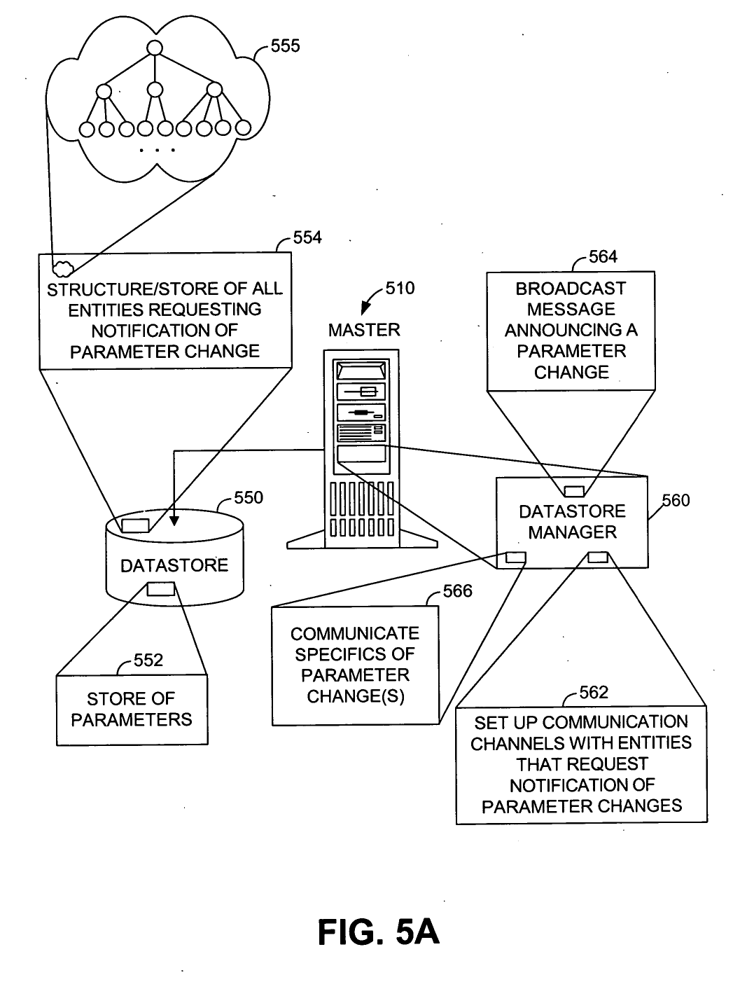

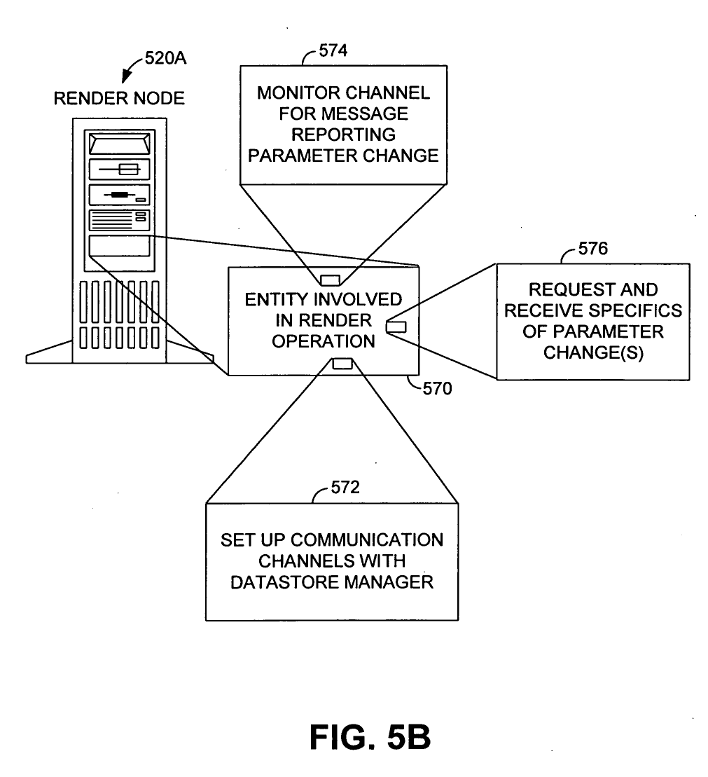

The description that follows describes various implementations for the handling of master/slave communication of various parameters and information. FIGS. 5A and 5B illustrate certain components that are utilized in one embodiment. Reference is first made to FIG. 5A, which illustrates components that are implemented on a master node 510 of such an embodiment. This embodiment utilizes a central datastore 550 that maintains a store 552 of the various parameters that are to be communicated to, and utilized by, the various slave computers that are cooperating to render a graphics image. In one embodiment, the datastore 550 is provided at the master computer 510 (or in connection with a master processor). In other embodiments, the datastore 550 is provided with one of the render computers (or processors) that are rendering the graphics image, or is provided on a separate computer (or processor) coupled to the network of computers rendering the graphics image. In yet other embodiments, the datastore may be a distributed datastore, distributed across or in connection with a variety of computers.

To facilitate the effective communication of parameter changes to requesting entities, the datastore 550 also includes a data structure 555 that efficiently specifies all of the entities that have requested a notification of a parameter change. In one implementation, such a structure is implemented as a linked-list of tuples. Therefore, when the datastore manager 560 detects that a given change has taken place in one or more parameters of the store of parameters 552, then the datastore manager 560 consults the data structure 555 to determine the entities that an appropriate broadcast message should be directed to. Likewise, when a given entity is created and registers with the datastore manager 560 that it be notified of any future changes in parameters (some or all parameters) stored on the datastore 550, the datastore manager 560 causes the data structure 555 to be updated with an appropriate identification of the requesting entity and/or an identification of the communication channel that has been established between the datastore manager 560 and the entity.

FIG. 5B illustrates a render node 520A. It should be appreciated that other computers in the cluster of render nodes 420 (e.g., FIG. 4) have components similar to those illustrated in connection with render node 520A of FIG. 5B. Render nodes 520A executes one or more programs that operate to render a portion of a graphics image. In the course of executing such programs, processes or threads are created, which operate to carry out various aspects of the program execution. These processes and threads are generically referred to herein as “entities.” It should be appreciated that there are a number of entities that may be created and running on a given render node 520A at any given time. FIG. 5B, for simplicity and ease of understanding, illustrates only one such entity 570. The other components associated with the entity 570 (illustrated in FIG. 5B), as well as the operational aspects of the entity 570 and related components, are similar for other entities created.

As mentioned above, there may be numerous entities running on a given computer or workstation configured as a render node 520A. Indeed, in a system with multiple render nodes cooperating to render a graphics image, at any given time there could be literally hundreds of active entities. After a given entity is created, logic 572 is provided in association with the entity to set up or establish (in cooperation with the master) a communication channel with a datastore manager 560 (FIG. 5A). Over this channel, the entity 570 requests that the datastore manager 560 inform the entity 570 whenever changes are made to one or more parameters that are in the central store 552 of parameters. Logic 574 is provided in association with the entity 570 for periodically monitoring the channel established by logic 572 for messages received from the datastore manager 560 that report a parameter change. Further, logic 576 is provided in association with the entity 570 for further communicating with the datastore manager 560 to request and receive specifics of parameter changes that have occurred.

Returning to FIG. 5A, a datastore manager 560 operates to provide overall controlling management of the datastore 550. The datastore manager 560 also comprises logic 562 that operates in response to, or in cooperation with, the logic 570 to establish communication channels with entities that request notification of parameter changes. The datastore manager 560 also comprises logic configured to broadcast a message to all entities that have requested to receive notification of parameter changes. In one embodiment, logic 564 broadcasts a short (e.g., one byte) message that is sent over all channels that have been established with the various entities having registered a request for notification that some change has been made to the parameters in the store of parameters 552. Logic 566 is further provided in connection with the datastore manager 560 for communicating specifics of parameter changes to the various entities.

To facilitate the effective communication of parameter changes to requesting entities, the datastore 550 also comprises a data structure that efficiently specifies all of the entities that have requested a notification of a parameter change. In one implementation, such a structure is implemented as an object store of datastore element objects. Therefore, when the datastore manager 560 detects that a given change has taken place in one or more parameters of the store of parameters 552, then the datastore manager 560 consults the data structure 554 to determine the entities that an appropriate broadcast message should be directed to. Likewise, when a given entity 570 is created and registers with the datastore manager 560 that it be notified of any future changes in parameters (some or all parameters) stored on the datastore 550, the datastore manager 560 causes the data structure 554 to be updated with an appropriate identification of the requesting entity 570 and/or an identification of the communication channel that has been established between the datastore manager 560 and the entity 570.

It should be appreciated that the diagrams of FIGS. 5A and 5B illustrate only certain components that are germane to one embodiment. For improved illustration purposes, conventional components and conventional logic utilized for carrying out various graphic operations have been omitted.

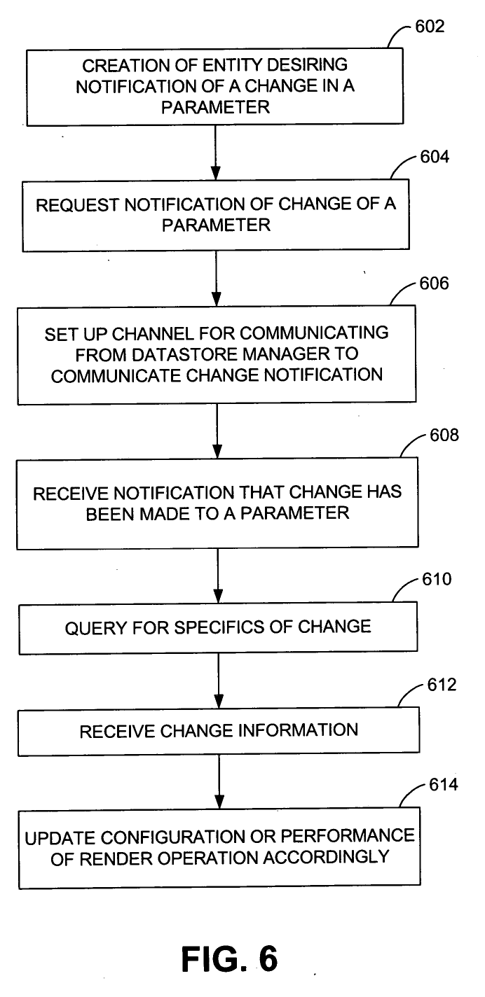

Reference is now made to FIG. 6, which is a flow chart illustrating a top-level functional operation of the embodiment illustrated in FIGS. 5A and 5B, in the context of a given entity that requests notification of changes to parameters affecting the rendering of a graphic image by the entity. First, in connection with the execution and operation of a render node, an entity is created, which desires notification of a change in a parameter that impacts its operation (602). Thereafter, the entity requests notification from a datastore manager of any parameter changes (604). The entity and datastore manager also cooperate to establish a channel over which the datastore manager communicates notifications to the entity of changes in a parameter (606). As mentioned above, in one embodiment such changes are communicated using a highly efficient, compact message (e.g., one byte) that be communicated (in broadcast or multicast form) to all interested entities. Each entity periodically monitors or polls its established channel until receiving notification that a change to a parameter has been made (608). The receiving entity queries the datastore manager for specifics of the change (610). In reply, the datastore manager instructs the entity of the changes that have been made (612). It should be appreciated that, in one embodiment, the communications of 610 and 612 occur over the same communication channel that was originally established between the entity and datastore manager for parameter-related communications. In another embodiment, the communications of 610 and 612 occur over a different communication channel (than the one that was originally established between the entity and datastore manager). Finally, the entity updates its configuration or performance of a given rendering operation in accordance with the changed parameter.

As noted above, in one embodiment, after receiving notification that a change has been made to one or more parameters, the receiving entity queries the datastore manager for specifics of the change. In one embodiment, the querying entity is informed of all parameters that have changed. In an alternative embodiment, the querying entity is informed of only certain parameters that are predetermined to impact the operation or configuration of the querying entity. In yet a further embodiment, the querying entity queries the master for the status of certain or specified parameters.

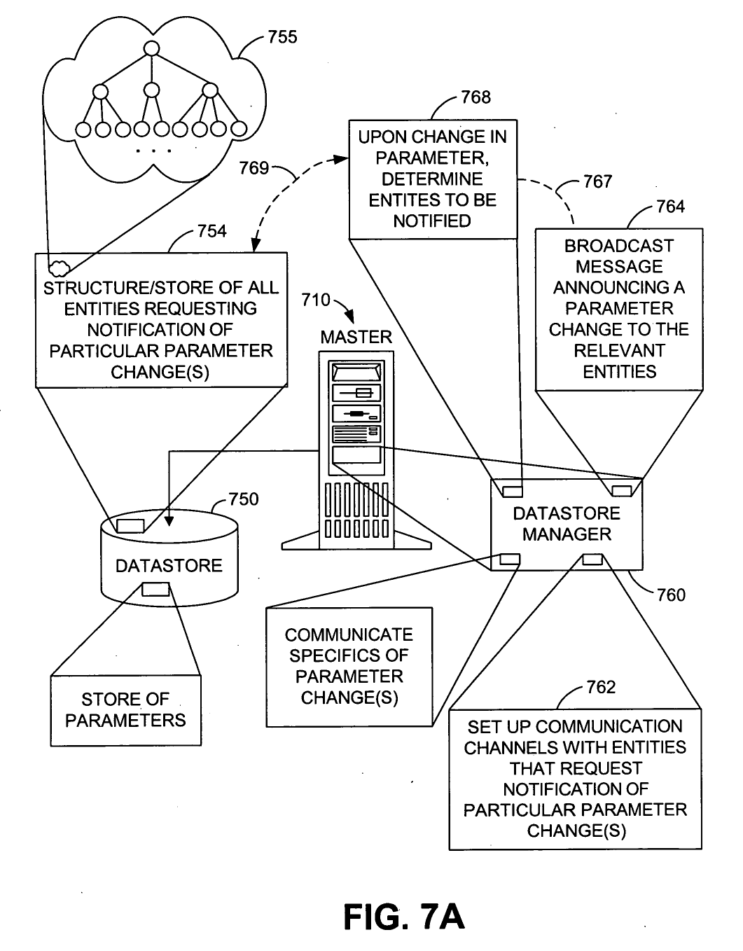

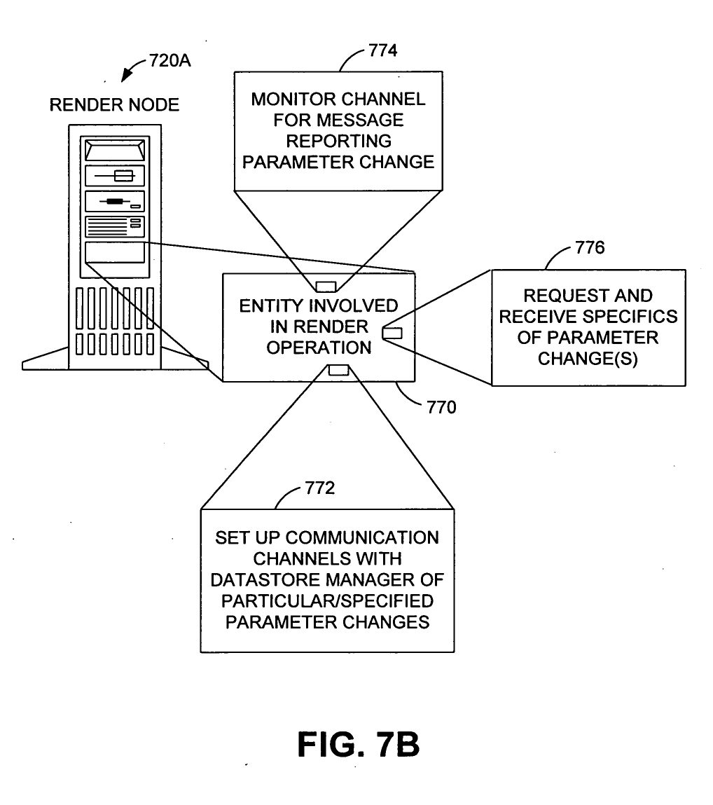

Having illustrated and described one embodiment of the present invention, reference is now made to FIGS. 7A and 7B, which illustrate an alternative embodiment. The diagram of FIG. 7A is similar to the diagram of FIG. 5A, and the diagram of FIG. 7B is similar to the diagram of FIG. 5B. Therefore, the description provided in connection with FIGS. 7A and 7B is abbreviated and certain components illustrated in FIGS. 7A and 7B are not again described, as their structural or operation is similar to that of corresponding components in FIGS. 5A and 5B. Turning first to FIG. 7A, a computer configured as a master 710 have an associated datastore 750 and datastore manager 760. The embodiment of FIGS. 7A and 7B differs from the embodiment of FIGS. 5A and 5B in that the embodiment of FIGS. 7A and 7B accommodates the request by entities to be notified of only certain parameter changes. That is, the embodiment of FIGS. 5A and 5B contemplates that any entity created, that was interested in a parameter change, receive notification from the datastore manager any time any of the parameters stored in the store parameters 552 changes. FIGS. 7A and 7B illustrate an embodiment whereby an entity registers a request to receive changes of only certain specified parameters or classes or categories of parameters. Accordingly, the data structure 754 provided in the embodiment of FIG. 7A is structured to enable ready identification, based upon a changed parameter, to determine the entities that have requested notification of such changes. Accordingly, the datastore manager 760 comprises logic 768 to determine the particular entities that are to be notified of the parameter change. As illustrated by dash line 769, logic 768 cooperates or interfaces with the data structure 754. Logic 762 of FIG. 7A is similar to logic 562 of FIG. 5A except that logic 762 establishes communication channels with entities that request notification of only particular or specified parameters (or classes of parameters) within the stored parameters 752. Likewise, logic 764 broadcasts messages announcing parameter changes only to the relevant entities that have requested notification of such changes. As illustrated by dash line 767, logic 764 cooperates or communicates with logic 768.

As described in connection with FIG. 5A, to facilitate the effective communication of parameter changes to requesting entities, the datastore 750 also includes a data structure 755 that efficiently specifies all of the entities that have requested a notification of a parameter change. In one implementation, such a structure is implemented as a linked-list of tuples. Therefore, when the datastore manager 760 detects that a given change has taken place in one or more parameters of the store of parameters 752, then the datastore manager 760 consults the data structure 755 to determine the entities that an appropriate broadcast message should be directed to. Likewise, when a given entity is created and registers with the datastore manager 760 that it be notified of any future changes in parameters (some or all parameters) stored on the datastore 7, the datastore manager 760 causes the data structure 755 to be updated with an appropriate identification of the requesting entity and/or an identification of the communication channel that has been established between the datastore manager 760 and the entity.

FIG. 7B illustrates logic provided at the render node 720A. Similar to the system illustrated in FIG. 5B, the render node 720A comprises at least one entity 770 that requests notification of certain specified changes in parameters that impact the rendering operation being performed by the entity 770. After creation of the entity 770, logic 772 establishes a communication channel with the datastore manager for notification of changes to certain specified parameters, types of parameters, categories of parameters, or classes of parameters. Thereafter, logic 774 monitors or polls the established channel for the receipt of messages reporting or broadcasting changes to the specified parameters. Logic 776 requests further identification from the datastore manager of specifics pertaining to the parameters that have been changed. Of course, the render node 720 further comprises logic that modifies the otherwise conventional operation of the entity in carrying out the render operation in accordance with the new or changed parameters.

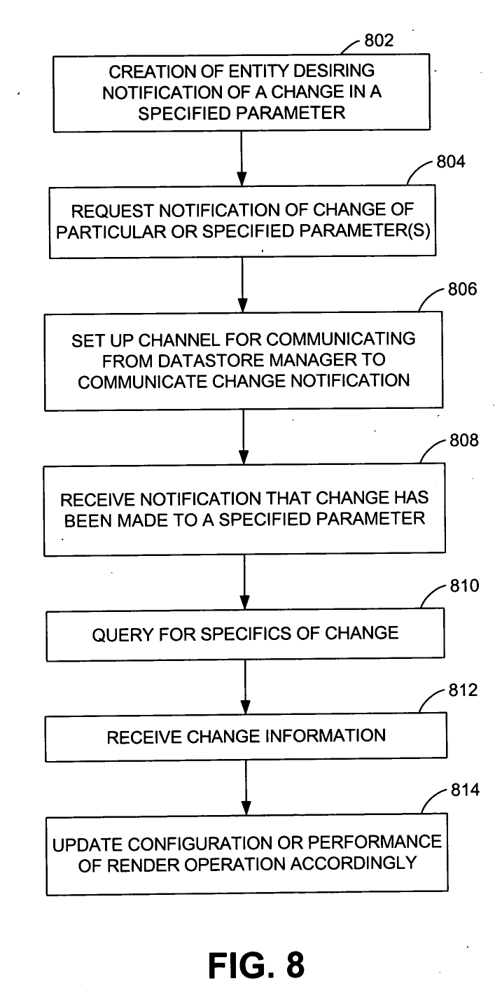

Reference is now made to FIG. 8, which is a flow chart similar to the flow chart of FIG. 6, illustrating top-level operation of the embodiment illustrated in FIGS. 7A and 7B. The illustrated operation begins with the creation of an entity desiring notification of a change in a specified parameter (802). The entity requests notification by the datastore manager, of changes of particular or specified parameters (804). Channels for communicating are established between the datastore manager and the entity, over which the datastore manager communicates change notifications to the entity (806). Upon the detection, by the datastore manager, of a change in a parameter and the determination (by the datastore manager) of the relevant entities to be notified, at least one specified entity receives notification that a change has been made to a specified parameter (808). In one embodiment, the entity queries the datastore manager for specifics regarding the parameter change (810). The entity receives information specifying the changed parameter (812), and updates its configuration or performance of rendering operation accordingly (814).

In accordance with the scope and spirit of the present invention, a variety of alternatives and embodiments may be implemented. For example, in one embodiment, entities desiring parameters simply make requests for the parameters (from the manager of the datastore storing the parameters) as the parameters are needed. In another embodiment an entity desiring uptodate parameters may register with the relevant datastore manager to receive notifications when changes are made to parameters of interest. In yet another embodiment, after creation of a given entity, a communication channel is established between the entity and the datastore manager for the entity to receive notifications of specific parameter changes that are made. Such an embodiment eliminates the additional steps of further communication between the datastore manager and the entities regarding specifics of the parameter changes. In one embodiment, when a change is made to a given parameter, the datastore manager causes information specifying that change to be broadcast to all entities that have requested (or registered for) a change notification. This broadcast message comprises information sufficient to specify the change that was made. Therefore, each entity receiving that broadcast message then has sufficient information to specify the change that was made; no further communications between the entities and the datastore manager need take place with respect to that change.

In yet another embodiment, upon creation of a given entity, the entity requests notification by the datastore manager of particular parameter changes that may be made. Upon a given a parameter change, the datastore manager determines which of the various entities requested notification about such a change. Once this determination is made, a broadcast message is sent to each entity having registered a request for such information. As in the previous embodiment just described, such a broadcast message comprises sufficient specificity regarding the parameter change that no further communication between the datastore manager and rendering node entities need be made.

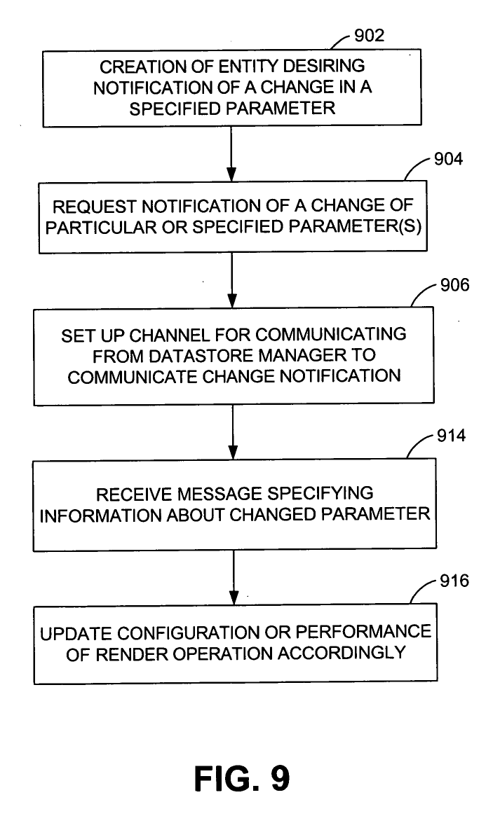

The operation of such an embodiment is illustrated in the flow chart of FIG. 9. In this embodiment, an entity is first created, which desires notification of a change in a specified parameter (902). After creation, that entity requests notification of a change of a particular or specified parameter (904). A communication channel is established between the entity and the datastore manager (906), over which information pertaining to parameter changes are communicated. A given entity receives a message specifying information about a parameter that has been changed (914). In response to the specified change, the render node updates its configuration or update the performance of its render operation accordingly (916).

Again, it will be appreciated that a variety of other embodiments may be implemented consistent with the scope and spirit of embodiments of the present invention. For example, the embodiments describe above have depicted the collective operation of multiple processors in the rendering of computer graphics. In one embodiment, the nodes may be allocated on independent computers or computer systems, such that multiple computer systems cooperate in a cluster to render a graphics image. In one embodiments, a node could comprise a single processor, while in other embodiments a processor may comprise multiple nodes.

What is claimed is:

1. A multi-node computer graphics system comprising:
a plurality of render nodes configured to collectively render a graphics image;
a datastore configured to store parameters that are used to control the rendering of the graphics image;
a datastore manager configured to manage the parameters stored in the datastore;
a plurality of entities associated with the plurality of render nodes, each of the plurality of entities being configured to implement an operation based on at least one parameter; and
logic associated with the plurality of render nodes for proactively retrieving at least one parameter from the datastore and communicating the retrieved parameter to at least one of the plurality of entities for using the parameter to implement an operation.

2. The system of claim 1, further comprising a master node, and the datastore is associated with the master node.

3. The system of claim 1, wherein each of the plurality of entities is one selected from the group consisting of a process and a thread.

4. The system of claim 1, further comprising logic associated with the datastore manager for notifying interested entities that a change has been made to at least one parameter stored in the datastore.

5. The system of claim 4, wherein the logic for notifying is configured to send a multicast message to the plurality of entities that have indicated an interest in being notified of changes to the parameters.

6. The system of claim 1, wherein each of the plurality of entities comprises logic responsive to the multicast message to query the datastore manager with regard to the specific parameters identified as having changed.

7. The system of claim 1, further comprising logic associated With the datastore manager for determining, responsive to changes in at least one of the parameters, which of the plurality of entities is interested in receiving notification of that change, and communicating a notification of the change to the determined entities.

8. The system of claim 1, further comprising a compositor configured to receive output signals from each of the plurality of render nodes and generate a single, composite signal for driving a display.

9. A computer graphics system comprising:
logic distributed across a plurality of nodes for collectively rendering a graphics image based on a plurality of specified parameters;
a datastore for storing the plurality of specified parameters;
logic associated with the logic distributed across the plurality of nodes for requesting information stored at the datastore, the requested information pertaining to a configuration or operational aspect of an entity associated with the plurality of nodes; and
logic associated with the logic distributed across the plurality of nodes for requesting information identifying a modification made to the information stored at the datastore and using modified information for updating a configuration or operational aspect of at least one of the plurality of nodes.

10. The system of claim 9, wherein the datastore is a central datastore.

11. The system of claim 9, wherein the datastore is a distributed datastore.

12. The system of claim 9, further comprising logic for notifying the plurality of nodes of a change to a parameter stored on the datastore.

13. The system of claim 12, wherein the logic for notifying is configured to notify each of a plurality of processes and each of a plurality of threads that have registered a request to be notified of a change made to the parameters.

14. The system of claim 12, wherein the logic for notifying is configured to notify only the processes and only the threads that have registered a request to be notified of a change made to the parameters.

15. A method for a multi-node computer graphics system comprising:
storing a plurality of parameters on a datastore, wherein the parameters are to be utilized by a plurality of computer systems for collectively rendering a graphics image;
creating an entity, for execution on one of the plurality of computer systems, that plays a role in rendering the graphics image;
requesting, by the entity, at least one parameter stored on the datastore; and
sending the requested parameter to the requesting entity.

16. The method of claim 15, further comprising:
sending a notification from the entity to a datastore manager requesting to be notified of a change in at least one parameter stored on the datastore.

17. The method of claim 16, further comprising:
sending a notification to the entity that a parameter has been changed.

18. The method of claim 15, further comprising determining that a change has been made to at least one parameter.

19. The method of claim 15, further comprising modifying a rendering operation performed by the entity in response to a change in an operating configuration, based on a change in the at least one parameter.

20. The method of claim 16, wherein the sending of the notification more specifically comprises sending a multicast message to all entities that requested a notification of a change to the at least one parameter.

21. The method of claim 20, further comprising communicating between the entities that received the broadcast message and the datastore manager to ascertain, by the entities, the specific change made to the parameter.

22. A multi-node computer graphics system comprising:
means for collectively rendering a graphics image;
means for storing parameters that are used to control the rendering of the graphics image; and
means, associated with the means for rendering, for proactively retrieving parameters from the means for storing and using the retrieved parameters in an operation related to graphics rendering.
